(19) United States
(12) Patent Application Publication
(10) Pub. No.: US 2020/0381153 A1
(43) Pub. Date: Dec. 3, 2020

(54) Truncated Flat Wire Coil

(71) Applicant: ASML Holding N.V., Veldhoven (NL)

(72) Inventor: Michael Emerson BROWN, Norwalk, CT (US)

(73) Assignee: ASML Holding N.V., Veldhoven (NL)

(21) Appl. No.: 16/761,534

(22) PCT Filed: Oct. 5, 2018
(86) PCT No.: PCT/EP2018/077079

§ 371 Date: May 5, 2020

Related U.S. Application Data
(60) Provisional application No. 62/581,835, filed on Nov. 6, 2017.

(51) Int. Cl. H01F 5/06; H01F 41/063; H02K 3/02; H02K 3/04; H01F 7/06; H01F 7/16

(52) U.S. Cl. CPC H01F 5/06; H01F 41/063; H01F 7/16; H02K 3/04; H01F 7/066; H02K 3/02

(57) ABSTRACT

A flat wire coil lacking electrically insulating material on its upper and/or lower surfaces. The lack of insulating material aids in maintaining the coil temperature as well as providing other benefits.

### CROSS-REFERENCE TO RELATED APPLICATIONS

This application claims priority of U.S. Provisional Patent Application No. 62/581,835, which was filed on Nov. 6, 2017, and which is incorporated herein in its entirety by reference.

### FIELD

Embodiments of the present invention generally relate to the field of heat control and dissipation in electromechanical devices and, more particularly, to the cooling of actuator coils.

### BACKGROUND

Motor coils are used in a wide array of applications including, for example, hard disk drives and lithography tools. In general, a motor coil includes an actuator coil that contains numerous windings of a wire and a magnetic device. The magnetic device can include one or more permanent magnets. An electric current passing through the actuator coil creates an electromagnetic field which interacts with a magnetic field produced from the magnetic device to cause a force to be exerted on the actuator coil. This force causes the actuator coil to move. In the alternative, the magnetic device can move, while the actuator coil remains stationary, when the electromagnetic field is established between the magnetic device and the actuator coil.

The movement of the actuator coil can be controlled by adjusting the electric current flowing through the actuator coil, where a force on the actuator coil is proportional to the electric current. To increase the force, the electric current must also be increased. However, as the current is increased, the operating temperature of the actuator coil also increases due to electrical energy dissipating as heat energy within the actuator coil. The resistance of the actuator coil, in turn, increases and the magnitude of the current flowing through the actuator coil is limited, thereby adversely affecting the performance of the motor coil.

One common solution for applications requiring a rapidly moving motor coil is the use of heat transfer elements. The heat transfer elements may be placed on top, bottom, and side surfaces of the actuator coil and configured to cool the outside layers of the coil. However, these heat transfer designs do not effectively transfer heat away from the inner layers of the coil, where the coil temperature can be at its highest.

There is thus a need to be able to provide a coil design that helps control heat generation and dissipation.

### SUMMARY

The following presents a simplified summary of one or more embodiments in order to provide a basic understanding of the embodiments. This summary is not an extensive overview of all contemplated embodiments, and is not intended to identify key or critical elements of all embodiments nor delineate the scope of any or all embodiments. Its sole purpose is to present some concepts of one or more embodiments in a simplified form as a prelude to the more detailed description that is presented later.

According to one aspect disclosed is a substantially planar coil of flat wire, the flat wire comprising a conductor having substantially rectangular cross section with a first pair of sides oriented substantially perpendicular to a plane of the coil and a second pair of sides oriented substantially parallel to a plane of the coil and an electrically insulating material on at least one of the sides of the first pair of sides, at least one of the sides of the second pair of sides lacking any electrically insulating material. The coil may be substantially circular or have a racetrack shape. There may be an electrically insulating material on both sides of the first pair of sides. There may be no electrically insulating material on both sides of the second pair of sides.

According to another aspect disclosed is an actuator comprising a permanent magnet and a substantially planar coil of flat wire, the flat wire including a conductor having substantially rectangular cross section with a first pair of sides oriented substantially perpendicular to a plane of the coil and a second pair of sides oriented substantially parallel to a plane of the coil and an electrically insulating material on at least one of the sides of the first pair of sides, at least one of the sides of the second pair of sides lacking any electrically insulating material, the permanent magnet and the coil being arranged such that a force is developed between them when a current of sufficient magnitude passes through the coil.

According to another aspect disclosed is a stage photolithographic apparatus for positioning a reticle or a wafer, the stage comprising a table and an actuator mechanically coupled to the table, the actuator including a permanent magnet, a substantially planar coil of flat wire, the flat wire including a conductor having substantially rectangular cross section with a first pair of sides oriented substantially perpendicular to a plane of the coil and a second pair of sides oriented substantially parallel to a plane of the coil and an electrically insulating material on at least one of the sides of the first pair of sides, at least one of the sides of the second pair of sides lacking any electrically insulating material, the permanent magnet and the coil being arranged such that a force is developed between them when a current of sufficient magnitude passes through the coil.

According to another aspect disclosed is a method of making a coil comprising the steps of providing a length of flat wire, the flat wire comprising a conductor having substantially rectangular cross section covered with an electrically insulating material, winding the length of flat wire into a substantially planar coil having a first substantially planar surface and a second substantially planar surface, and removing the electrically insulating material from at least a portion of the first substantially planar surface. The removing step may carried out at least in part by machining. The removing step may carried out at least in part by single point fly cutting. The removing step may carried out at least in part by milling. The method may comprise an additional step after the removing step of removing some of the conductor to regulate an electrical property of the coil. The electrical property may be resistance. The method may comprise an additional step after the removing step of measuring an electrical resistance of the coil. The method may comprise an additional step after the removing step of measuring a Q factor of the coil.

According to another aspect disclosed is a method of making a coil comprising the steps of providing a sheet of conductive material, covering at least one side of the sheet with a layer of an electrically insulating material, rolling the sheet and layer to form a roll, and cutting the roll transverse to a length of the roll to form a coil.

Further embodiments, features, and advantages of the present invention, as well as the structure and operation of the various embodiments are described in detail below with reference to accompanying drawings.

### BRIEF DESCRIPTION OF THE DRAWING

The accompanying drawings, which are incorporated herein and form part of the specification, illustrate the methods and systems of embodiments of the invention by way of example, and not by way of limitation. Together with the detailed description, the drawings further serve to explain the principles of and to enable a person skilled in the relevant art(s) to make and use the methods and systems presented herein. In the drawings, like reference numbers indicate identical or functionally similar elements.

FIG. 1A is a front diagram of an actuator.

FIG. 1B is a side diagram of the actuator of FIG. 1B.

FIG. 2 is an illustration of an exemplary motor coil.

FIG. 3 is cross sectional view of the exemplary motor coil of FIG. 2 taken along line AA of FIG. 2.

FIG. 4 is cross sectional view of the motor coil according to one aspect of the invention.

FIG. 5 is an illustration of an exemplary lithographic apparatus that can implement embodiments of the coil according to the invention.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art based on the teachings contained herein.

### DETAILED DESCRIPTION

Various embodiments are now described with reference to the drawings, wherein like reference numerals are used to refer to like elements throughout. In the following description, for purposes of explanation, numerous specific details are set forth in order to promote a thorough understanding of one or more embodiments. It may be evident in some or all instances, however, that any embodiment described below can be practiced without adopting the specific design details described below. In other instances, well-known structures and devices are shown in block diagram form in order to facilitate description of one or more embodiments. The following presents a simplified summary of one or more embodiments in order to provide a basic understanding of the embodiments. This summary is not an extensive overview of all contemplated embodiments, and is not intended to identify key or critical elements of all embodiments nor delineate the scope of any or all embodiments.

In the description that follows and in the claims the terms “up,” “down,” “top,” “bottom,” “vertical,” “horizontal,” and like terms may be employed. These terms are intended to show relative orientation only and not any orientation with respect to gravity.

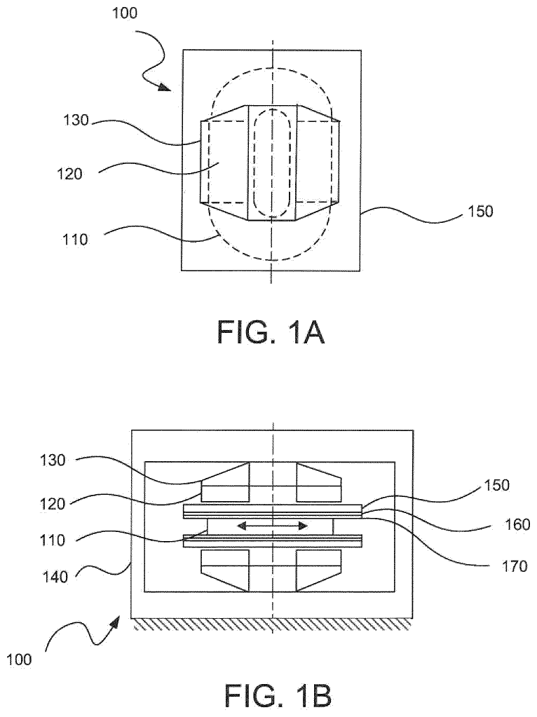

FIGS. 1A and 1B are illustrations of an exemplary motor coil 100 with an actuator coil 110 and permanent magnets 120. While a single phase coil is shown in in FIGS. 1A and 1B it will be appreciated that such coils can be multiphase, in particular, three phase. Permanent magnets 120 can be coupled to a back iron plate 130, as actuator coil 110 moves within an enclosure 140 (FIG. 1B) housing motor coil 100. In the alternative, actuator coil 110 can be in a fixed or stationary position as permanent magnets 120 move within enclosure 140. For explanatory purposes, it will be assumed that actuator coil 110 moves within enclosure 140, while permanent magnets 120 are in a fixed or stationary position. A cooling body 150 is placed in thermal communication with the coil 110 through a layer 160 of electrical insulator and a layer 170 of a heat transfer material.

The movement of actuator coil 110 can be controlled by adjusting an electric current flowing through actuator coil 110, where a force on actuator coil 110 is proportional to the electric current. More specifically, to increase the force on actuator coil 110, electric current flowing through actuator coil 110 must also be increased. However, as the electric current is increased, an operating temperature of actuator coil 110 also increases due to electrical energy dissipating as heat energy within actuator coil 110. A resistance of actuator coil 110, in turn, increases and a magnitude of the current flowing through actuator coil 110 is limited, thereby adversely affecting the performance of motor coil 100.

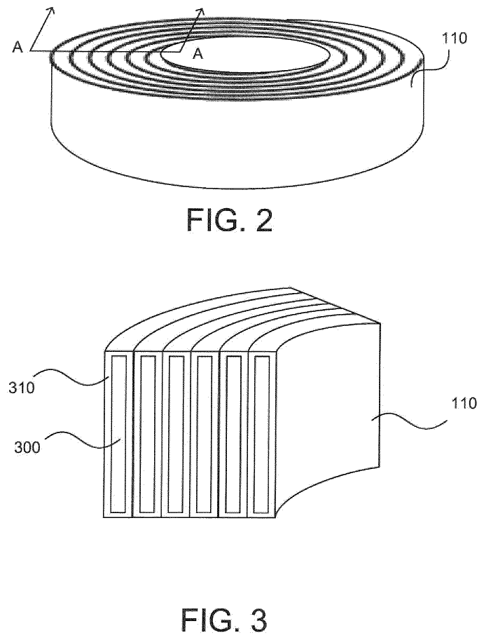

FIG. 2 is an illustration of a coil 110. Coil 110 is made from insulated flat wire. For example, some reticle stages and wafer stages of lithographic tools use electric actuators with electrical coils made from insulated flat wire to provide motive force. Flat wire coils are made per order by rolling uninsulated round wire to the desired thickness and then coating the rolled wire with insulation and a bonding layer. In one example, each turn in actuator coil 110 is be held in place using, for example, a potting material. FIG. 3 is a cross section of the coil 110 of FIG. 2. As can be seen, each turn of the coil 110 includes a substantially rectangular central conductive portion 300 surrounded by an electrically insulating material 310. It will be noted that the top and the bottom of the substantially rectangular central conductive portion 300 may actually be slightly rounded as an artifact of the method used to make the flat wire. The cross section is nonetheless still “substantially rectangular” as that term is used herein. The wound coil 110 has upper and lower parallel planar surfaces. The substantially rectangular central conductive portion 300 has two sets of parallel sides, a first pair of sides oriented generally vertically, that is, perpendicular to the plane of the parallel planar surfaces and a second pair of sides oriented generally horizontally, that is, parallel to the plane of the parallel planar surfaces. Although a substantially circular or cylindrical coil is shown, it will be appreciated by one of ordinary skill in the art that coils of other shapes may be used, such as an oval shape or a racetrack shape.

During operation the coils heat up and need to be cooled to meet lifetime and/or throughput requirements. Actuator coil lifetime is directly related to coil temperatures. Cooler coils are desired to improve actuator lifetime (reduced thermal stress of potting) and/or system throughput (increased power handling capability) and/or overlay (reduced thermal distortion) of existing systems. Future designs will impose even greater thermal demands.

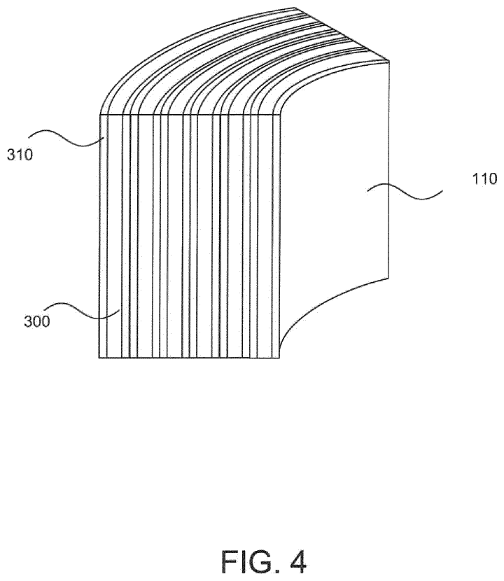

There thus remains a need to provide a flat wire coil that exhibits lower coil temperatures. The thermal performance of a conventional flat wire coil is improved by removing the outer layer(s) of electrical insulation and some conductor on the flat end(s) of the coil via machining or other method resulting in a truncated flat wire coil. Such a coil is shown in in cross section in FIG. 4. As can be seen, the insulation 310 and some of the conductor has been removed from the top and bottom surfaces of the coil 110. The removal of the insulation promotes dissipation of the heat generated in the coil 110 when it is in use.

The removal of the layer(s) eliminates thermal insulation between the electrical conductor and an external cooling sink. This lowers the coil and coil potting epoxy temperatures. If the coils are machined from conventional flat wire coils, final thickness and flatness tolerances can be reduced. This allows a reduction in potting layer thickness which is often used to absorb tolerances in the actuator assembly. The thinner potting also improves cooling. The removal of the insulation reduces the overall thickness of the actuator which results in other benefits. This allows yoke magnets to be closer together which reduces fringing fields. This increases motor efficiency so less current is needed. Since power varies with square of the current this results in a reduction of coil temperature as well. Alternatively, the actuator can remain the same thickness and the conductor height can be increased. A larger conductor uses less power and so temperatures can be reduced even further.

Electrical isolation is not compromised despite the removal of top and/or bottom insulation. Actuator coils are designed so the entire coil is insulated from its container to meet International Electrotechnical Commission requirements. Within the coil itself the voltage difference between neighboring wire turns is low, typically on the order of one volt, so the gap between exposed wires is sufficient insulation.

As mentioned, flat wire coils are made per order by rolling uninsulated round wire to the desired thickness. The thickness is held to tight tolerances and the height tolerance is typically much larger. The process results in wire with a rounded “top” and “bottom.” The rounded ends and large height tolerances make it difficult to estimate the coil electrical resistance very accurately during the design phase. Truncating the coil results in lower height tolerances, squared off ends, and reduced flatness. This creates the potential for more accurate calculations and more repeatable resistance values. It also allows even greater tolerance on the height of the wire since they are machined to the desired final height. Truncating the height means different height coils can be fabricated from the same stock of wire which reduces the number of stocks of different types of wire that must be maintained. This design allows greater tolerances in the winding tooling used to set the coil height. The resistance of an individual coil can be measured and tuned by removing material although this may result in coils of varying thicknesses. The top and bottom of flat wire coils often exhibit a dogbone-shaped crimping of insulation which can affect winding quality. Truncation removes the crimping and so winding quality may be improved.

An alternative to modifying a conventional flat wire coil is to make wire with uninsulated top and/or bottom surfaces. It should be noted that during coil winding the adhesive layer on the wire will likely extrude out over the bare wire. This increases the thermal insulation (and temperature) and may increases the part tolerance. Another alternative to modifying a conventional flat wire coil is to use a “jellyroll” process. One or both sides of a sheet of foil is covered with insulation plus bonding layer, wound into a “jelly roll”, heated to cure the bonding layer, and then sliced into coils of desired thicknesses. Individual coils or coils already bonded in a stack may be modified. Individual coils may be modified on one or two sides.

There are several methods that could be used for removing the insulation. For example, single point fly cutting could be used to modify a flat copper wire coil. Surface grinding may also be used. Milling may also be used. The term “machining” is intended to encompass at least any of these methods. Electrical resistance measurement can be used to detect the presence of short circuits between windings. Alternatively or on addition, the quality factor (ratio of inductance L to the resistance R) of the coil can be measured to obtain a more accurate determination.

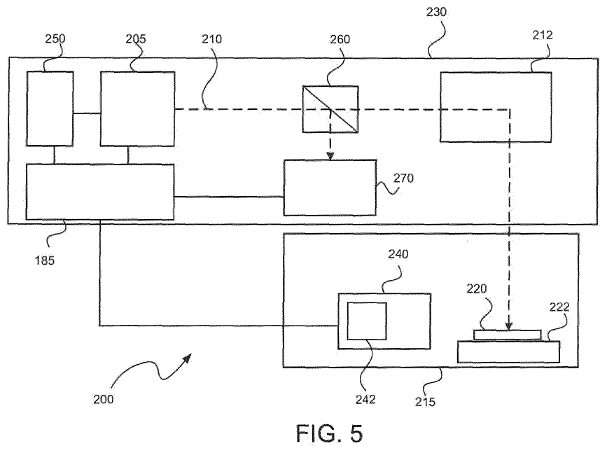

A truncated flat wire coil and an actuator incorporating a truncated flat wire coil may be used, for example to position a wafer stage or a reticle stage in a photolithography system. Referring to FIG. 5, a photolithography system 200 includes an illumination system 230. The illumination system 230 includes an optical source 205 that produces a pulsed light beam 210 and directs it to a photolithography exposure apparatus or scanner 215 that patterns microelectronic features on a wafer 220. The wafer 220 is placed on a wafer table 222 constructed to hold wafer 220 and connected to a positioner configured to accurately position the wafer 220 in accordance with certain parameters. The light beam 210 is also directed through a beam preparation system 212, which can include optical elements that modify aspects of the light beam 210. For example, the beam preparation system 212 can include reflective or refractive optical elements, optical pulse stretchers, and optical apertures (including automated shutters). a spectral feature selection system 250 that finely tunes the spectral output of the optical source 205 based on an input from a control system 185.

The photolithography system 200 uses a light beam 210 having a wavelength, for example, in the deep ultraviolet (DUV) range or the extreme ultraviolet (EUV) range. The lithography system 100 also includes a measurement (or metrology) system 270, and the control system 185. The metrology system 270 measures one or more spectral features (such as the bandwidth and/or the wavelength) of the light beam. The metrology system 270 preferably includes a plurality of sensors. The metrology system 270 receives a portion of the light beam 210 that is redirected from a beam separation device 260 placed in a path between the optical source 205 and the scanner 215. The beam separation device 260 directs a first portion of the light beam 210 into the metrology system 270 and directs a second portion of the light beam 210 toward the scanner 215. In some implementations, the majority of the light beam is directed in the second portion toward the scanner 215. For example, the beam separation device 260 directs a fraction (for example, 1-2%) of the light beam 210 into the metrology system 270. The beam separation device 260 can be, for example, a beam splitter.

The scanner 215 includes an optical arrangement having, for example, one or more condenser lenses, a mask, a reticle, and an objective arrangement. The mask is movable along one or more directions, such as along an optical axis of the light beam 210 or in a plane that is perpendicular to the optical axis. The objective arrangement includes a projection lens and enables the image transfer to occur from the mask to the photoresist on the wafer 220. The illuminator system adjusts the range of angles for the light beam 210 impinging on the mask. The illuminator system also homogenizes (makes uniform) the intensity distribution of the light beam 210 across the mask.

The scanner 215 can include, among other features, a lithography controller 240, air conditioning devices, and power supplies for the various electrical components. The lithography controller 240 controls how layers are printed on the wafer 220. The lithography controller 240 includes a memory 242 that stores information such as process recipes and also may store information about which repetition rates may be used or are preferable as described more fully below.

The wafer 220 is irradiated by the light beam 210. A process program or recipe determines the length of the exposure on the wafer 120, the mask used, as well as other factors that affect the exposure. During lithography, a plurality of pulses of the light beam 110 illuminates the same area of the wafer 220 to constitute an illumination dose. The number of pulses N of the light beam 210 that illuminate the same area can be referred to as an exposure window or slit and the size of this slit can be controlled by an exposure slit placed before the mask.

One or more of the mask, the objective arrangement, and the wafer 220 can be moved relative to each other during the exposure to scan the exposure window across an exposure field. The exposure field is the area of the wafer 220 that is exposed in one scan of the exposure slit or window.

The embodiments may further be described using the following clauses:

1. A substantially planar coil of flat wire, the flat wire comprising:

a conductor having substantially rectangular cross section with a first pair of sides oriented substantially perpendicular to a plane of the coil and a second pair of sides oriented substantially parallel to a plane of the coil; and

an electrically insulating material on at least one of the sides of the first pair of sides,

at least one of the sides of the second pair of sides lacking any electrically insulating material.

2. A substantially planar coil of clause 1 wherein the coil is substantially circular.
3. A substantially planar coil of clause 1 wherein the coil has a racetrack shape.
4. A substantially planar coil of clause 1 wherein there is an electrically insulating material on both sides of the first pair of sides.
5. A substantially planar coil of clause 1 wherein there is no electrically insulating material on both sides of the second pair of sides.
6. An actuator comprising:

a permanent magnet; and

a substantially planar coil of flat wire, the flat wire including a conductor having substantially rectangular cross section with a first pair of sides oriented substantially perpendicular to a plane of the coil and a second pair of sides oriented substantially parallel to a plane of the coil and an electrically insulating material on at least one of the sides of the first pair of sides, at least one of the sides of the second pair of sides lacking any electrically insulating material,

the permanent magnet and the coil being arranged such that a force is developed between them when a current of sufficient magnitude passes through the coil.

7. In a photolithographic apparatus, a stage for positioning a reticle or a wafer, the stage comprising:

a table; and

an actuator mechanically coupled to the table, the actuator including a permanent magnet, a substantially planar coil of flat wire, the flat wire including a conductor having substantially rectangular cross section with a first pair of sides oriented substantially perpendicular to a plane of the coil and a second pair of sides oriented substantially parallel to a plane of the coil and an electrically insulating material on at least one of the sides of the first pair of sides, at least one of the sides of the second pair of sides lacking any electrically insulating material, the permanent magnet and the coil being arranged such that a force is developed between them when a current of sufficient magnitude passes through the coil.

8. A method of making a coil comprising the steps of:

providing a length of flat wire, the flat wire comprising a conductor having substantially rectangular cross section covered with an electrically insulating material;

winding the length of flat wire into a substantially planar coil having a first substantially planar surface and a second substantially planar surface; and

removing the electrically insulating material from at least a portion of the first substantially planar surface.

9. A method of clause 8 wherein the removing step is carried out at least in part by machining.
10. A method of clause 8 wherein the removing step is carried out at least in part by single point fly cutting.
11. A method of clause 8 wherein the removing step is carried out at least in part by milling.
12. A method of clause 8 further comprising a step after the removing step of removing some of the conductor to regulate an electrical property of the coil.
13. A method of clause 10 wherein the electrical property is resistance.
14. A method of clause 8 comprising a step after the removing step of measuring an electrical resistance of the coil.
15. A method of clause 8 comprising a step after the removing step of measuring a Q factor of the coil.
16. A method of making a coil comprising the steps of:

providing a sheet of conductive material;

covering at least one side of the sheet with a layer of an electrically insulating material; rolling the sheet and layer to form a roll; and

cutting the roll transverse to a length of the roll to form a coil.

The above description includes examples of multiple embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is construed when employed as a transitional word in a claim. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

1-16. (canceled)

17. A device comprising:
a conductor having substantially rectangular cross section with a first pair of sides oriented substantially perpendicular to a plane of a coil and a second pair of sides oriented substantially parallel to a plane of the coil; and
an electrically insulating material on at least one of the sides of the first pair of sides,
at least one of the sides of the second pair of sides lacking any electrically insulating material.

18. The device of claim 17, wherein the coil is substantially circular.

19. The device of claim 17, wherein the coil has a racetrack shape.

20. The device of claim 17, wherein there is an electrically insulating material on both sides of the first pair of sides.

21. The device of claim 17, wherein there is no electrically insulating material on both sides of the second pair of sides.

22. An actuator comprising:
a permanent magnet; and
a device of flat wire, the flat wire including a conductor having substantially rectangular cross section with a first pair of sides oriented substantially perpendicular to a plane of the coil and a second pair of sides oriented substantially parallel to a plane of the coil and an electrically insulating material on at least one of the sides of the first pair of sides, at least one of the sides of the second pair of sides lacking any electrically insulating material,
wherein the permanent magnet and the coil are arranged such that a force is developed between them in response to a current of sufficient magnitude passing through the coil.

23. A stage comprising:
a table; and
an actuator mechanically coupled to the table, the actuator including a permanent magnet and a device of flat wire,
wherein the flat wire comprises:
a conductor having substantially rectangular cross section with a first pair of sides oriented substantially perpendicular to a plane of a coil and a second pair of sides oriented substantially parallel to a plane of the coil, and
an electrically insulating material on at least one of the sides of the first pair of sides, at least one of the sides of the second pair of sides lacking any electrically insulating material,
wherein the permanent magnet and the coil are arranged such that a force is developed between them in response to a current of sufficient magnitude passing through the coil.

24. A method of making a coil comprising:
providing a length of flat wire, the flat wire comprising a conductor having substantially rectangular cross section covered with an electrically insulating material;
winding the length of flat wire into a device having a first substantially planar surface and a second substantially planar surface; and
removing the electrically insulating material from at least a portion of the first substantially planar surface.

25. The method of claim 24, wherein the removing is carried out at least in part by machining.

26. The method of claim 24, wherein the removing is carried out at least in part by single point fly cutting.

27. The method of claim 24, wherein the removing is carried out at least in part by milling.

28. The method of claim 24, further comprising removing some of the conductor to regulate an electrical property of the coil after the removing of the electrically insulating material.

29. The method of claim 28, wherein the electrical property is resistance.

30. The method of claim 24, comprising measuring an electrical resistance of the coil after the removing of the electrically insulating material.

31. The method of claim 24, comprising measuring a Q factor of the coil after the removing of the electrically insulating material.

32. A method of making a coil comprising:
providing a sheet of conductive material;
covering at least one side of the sheet with a layer of an electrically insulating material;
rolling the sheet and layer to form a roll; and
cutting the roll transverse to a length of the roll to form a coil.
